(19) United States
(12) Patent Application Publication
(10) Pub. No.: US 2007/0044068 A1
(43) Pub. Date: Feb. 22, 2007

(54) Using a visual, object-oriented methodology to describe an apparatus

(76) Inventor: Maad Abu-Ghazalah, Pacifica, CA (US)

Correspondence Address: Maad Abu-Ghazalah, P.O. Box 1219, Pacifica, CA, 94044, US

(21) Appl. No.: 11/507,235

(22) Filed: Aug. 21, 2006

Related U.S. Application Data
(60) Provisional application No. 60/710,266, filed on Aug. 22, 2005.

(51) Int. Cl. G06F 9/44

(52) U.S. Cl. 717/105; 717/104

(57) ABSTRACT

A method for describing an apparatus is provided whereby visual and objected-oriented tools are used to provide a description of the relevant parts of the apparatus as well as their relationship to each other.

I claim priority to provisional application No. 60/710,266 filed Aug. 22, 2005.

### BACKGROUND OF THE INVENTION

1. Field of the Invention

The present invention relates to an improved data processing system.

2. Description of Related Art

With the exponential increase in the number of apparatus inventions in the last century, there has been an equally large increase in the need to be able to describe these inventions. These descriptions are needed for various uses such as users' guides, training manuals and invention disclosure statements created by the inventor which are used in patent prosecution.

In spite of the high demand for a method to describe the myriads of apparatus that are in use in the modern world, very few methods exist for systematically describing these apparatus. Some software, such as Doc-to-Help® by ComponentOne®, exists for helping describe software and in creating users' guides and documentation, but this software still requires long, text-based descriptions of the apparatus in question and do not address the problem that inventors are typically not very adept at writing long, text based descriptions. Because of this problem, a specialist more adept at using words is typically required to provide a text-based description of the apparatus. However, no current system exists to help the inventor describe his or her invention nor of helping the inventor write a text-based description.

### SUMMARY OF THE INVENTION

A method for describing an apparatus is provided whereby visual and objected-oriented tools are used to provide a description of the relevant parts of the apparatus as well as their relationship to each other.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1 is a flow chart depicting the process through which visual tools are used to describe an invention.

FIG. 2 is a flow chart depicting a text generating algorithm used to convert the data structures created in FIG. 1 to text sentences.

FIG. 3 is a screen shot of a software application that implements the methodology described herein.

### DETAILED DESCRIPTION OF THE INVENTION

The current invention is a method and software application for describing an apparatus using visual and object oriented tools.

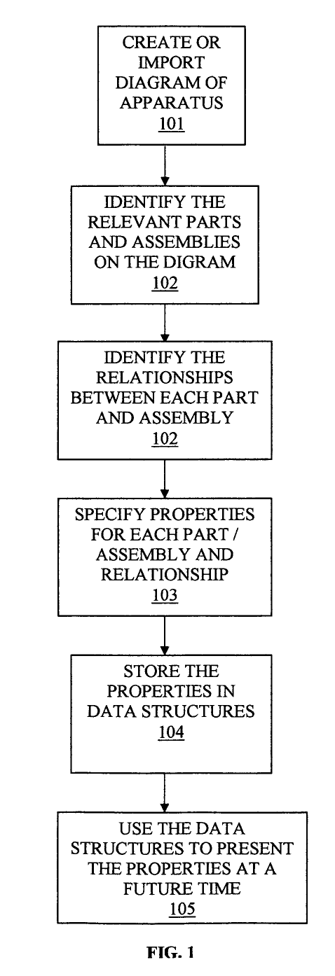

Referring to FIG. 1, a flow chart depicts the process by which an apparatus is described using visual tools. The process starts by either creating or importing a diagram of the apparatus (step 101). If the diagram is imported, any standard image format can be used, e.g. jpg or tiff.

Next, the relevant parts and assemblies are identified on the diagram (step 102). By definition, an assembly consists of one or more parts. Parts may be identified, for example, by using a pointing device such as a mouse to draw a circle or square around the location of the part in the diagram. Assemblies may then be identified, for example, by clicking on the location of each part of the assembly in the diagram. Parts and assemblies of the apparatus that are not relevant (i.e. important) need not be identified.

The relationships between parts and assemblies is then identified (step 103). For example, a pointing device such as a mouse may be used to select a first part or assembly. Then the pointing device may be used to select each part and/or assembly the first part or assembly is related to.

Parts, assemblies and relationships are called “objects”. The properties of each object are then specified (step 103). The properties can include the object's name, description and purpose. However, other properties, such as the object's manufacturing part number, its color, or its temperature range may also be included.

The order in which this information is specified is not relevant. For example, all the objects may be identified first, then the properties specified or, alternatively, the properties for each object may be specified immediately after that object is identified.

The information for each object (i.e. its x, y coordinates within the diagram as well as its properties) is stored in data structures (step 105). These data structures can be used at a future time to present the objects and their properties (step 106). For example, a pointing device, such as a mouse, can be used to select the location of a part or assembly. The data structures can then be used to identify which part or assembly was selected and then present the properties and relationships of that part or assembly.

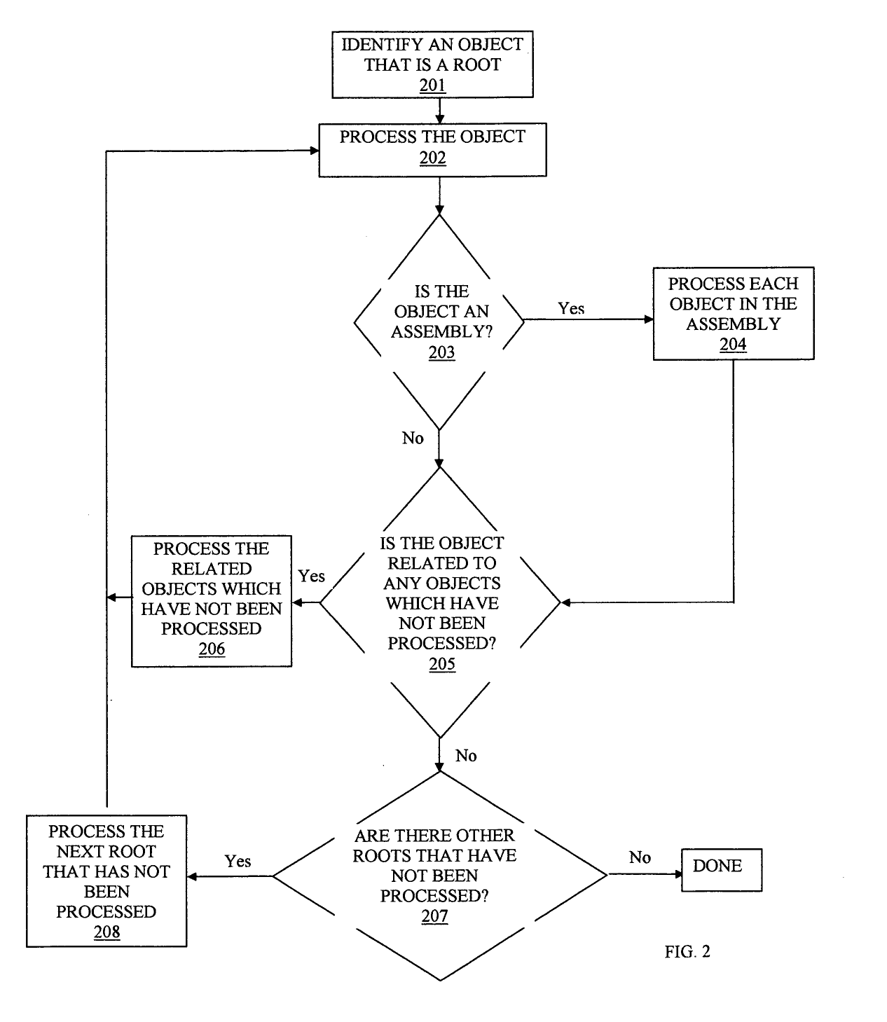

In addition to merely presenting the properties and relationships of objects once they are selected, an algorithm can be used to output the data structures by generating text sentences. FIG. 2 presents a flow chart of such a text generating algorithm.

Start by identifying a “root” object (step 201). A “root” object is a part or assembly that is not a component of another assembly. Process the root object by generating sentences from the object's properties (step 202).

For example, in a motorcycle apparatus, a root object may have the following properties:

1) ID: 1

2) Name: Shock Absorber

3) Description: a spring

4) Purpose: reduces vibrations

Sentences that can be generated from these properties are:

1) Shock Absorber 1 is a spring.
2) Shock Absorber 1 reduces vibrations.

Next, determine if the object is an assembly of other objects (step 203). If so, process each object in the assembly (step 204). For example, the shock absorber may be an assembly of a coil and a pair of bolts. Therefore, the sentences created from the properties of the coil would be generated followed by the sentences for the pair of bolts.

Next, determine if the object is related to any other object which has not yet been processed (step 205). If so, process each related object that has not been processed yet (step 205). For example, the shock absorber may be related to the wheel. If so, sentences from the properties of the wheel would then be generated.

Once the related objects have been processed, determine if there are any other roots that have not been processed yet (step 206). If so, process each root (step 207) and follow steps 202 to 207.

Once all the roots have been processed, the algorithm is complete.

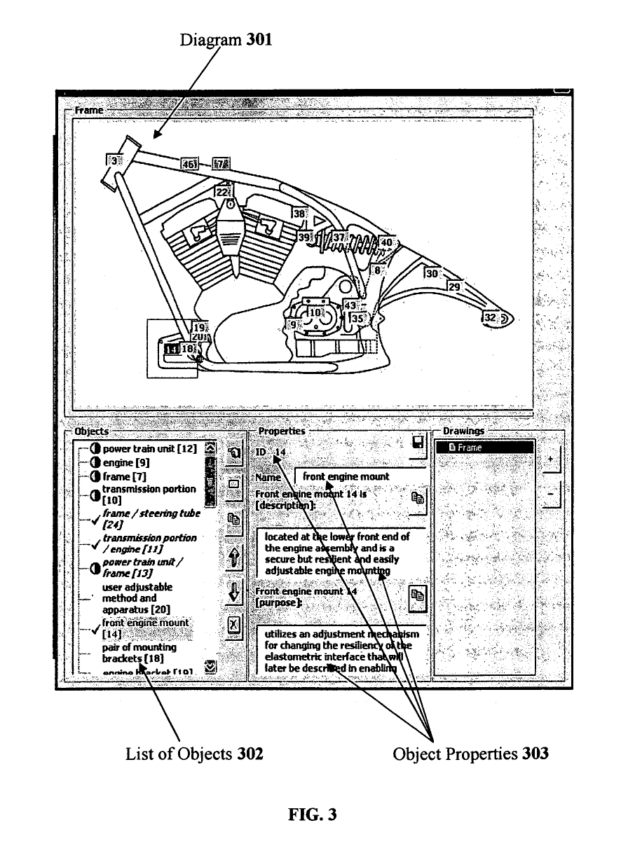

Referring now to FIG. 3, a screen shot depicts an application that implements the current invention. The diagram 301 appears on the top of the screen. The diagram may be a jpg file that is imported into the application.

A list of objects 302 is displayed in the lower right of the screen and the object properties 303 of the currently selected object are displayed in the lower center of the screen.

The user of the application starts by importing a diagram of the apparatus, which is displayed on the top of the screen. The user then identifies objects by using a pointing device such as a mouse to circle the location of each object on diagram 301. Once the object has been identified, the user then fills in the object properties 303.

For example, in the screen shot in FIG. 3, the selected object is in the lower left corner of the diagram and has a box around it. The object properties 303 appear in the lower center of the screen and include the following properties: ID, Name, Description and Purpose. An example of properties for an object is:

1) ID: 37

2) Name: Shock Absorber

3) Description: a spring

4) Purpose: contracts and expands with the movements of the motorcycle

The user can then identify relationships between objects. For example, the user can use a pointing device such as a mouse to select an object. Then the user can use the pointing device to identify the objects that the selected object is related to. Once the relationship has been identified, the user can then specify properties for the relationship.

For example, the user can first select the shock absorber. The user then can identify that the shock absorber is related to the frame (which is another object that has been identified on the diagram 301). The user then specifies the properties of the relationship, for example the Description and Purpose of the relationship, e.g.:

1) Description: is mounted to

2) Purpose: to reduce vibrations

Finally, when all the objects and their properties and relationships have been entered, the application can generate text sentences based on the values entered.

In the example above, the application would generate the following sentences:
1) Shock Absorber 37 is a spring.
2) Shock Absorber 37 contracts and expands with the movements of the motorcycle
3) Shock Absorber 37 is mounted to Frame 38 to reduce vibrations.

Once the objects and their properties have been entered, the data can be validated and checked for completeness. For example, a software routine can check if properties have been entered for each object. If one or more properties for an object has not been entered, the routine would provide a warning.

In addition, a software routine can check if each part and assembly is either a part of an assembly or is related to some other part or assembly and provide a warning message for each part and assembly that is not. Such a warning is useful because a part or assembly that is not related to any other part or assembly may not be important to the apparatus.

For the sake of efficiency, a library of objects may be used. The library consists of a list of objects and properties. So, for each apparatus, Rather than re-writing the properties of an object, the object can be selected from the library and the properties of the object are automatically imported.

For example, the library may contain a list of objects and two properties, “name” and “description.” One of the objects in the library may have a “name” value of “shock absorber”, and “description” value of “is a spring”. When an apparatus that contains a shock absorber is being described, rather than having to re-enter the “name” and “description” property values of the shock absorber, the shock absorber can be identified by circling its location on the diagram then selecting the shock absorber from the library. The “name” and “description” values of the shock absorber would then be automatically imported from the library.

A method and apparatus for describing an apparatus using visual and object oriented tools comprising:

1. A method and apparatus for describing an apparatus comprising the following steps:
A. Importing or creating a diagram of the invention.
B. Identifying the parts and assemblies in the diagram.
C. Specifying properties for each part and assembly.
D. Identifying relationships between each part and assembly
E. Storing the information created in steps A through D in data structures.
F. Whenever a part or assembly is selected in the diagram, presenting that part or assembly's properties and relationships stored in the data structures.

2. A method and apparatus for describing an apparatus as in claim 1 whereby the data structures are used to generate text sentences using a text generating algorithm.

3. A method and apparatus for describing an apparatus as in claim 1 whereby the data structures are validated to check that properties have been entered for each part and assembly and to provide a warning message for each part and assembly that do not have properties entered.

4. A method and apparatus for describing an apparatus as in claim 1 whereby the data structures are validated to ensure that each part and assembly has a relationship identified with at least one other part or assembly.

5. A method and apparatus for describing an apparatus as in claim 1 whereby the parts and assemblies can be selected from a library of parts and assemblies whose properties are then automatically imported and stored in the data structures.
